(19) United States
(12) Patent Application Publication
(10) Pub. No.: US 2011/0033589 A1
(43) Pub. Date: Feb. 10, 2011

(54) METHOD AND APPARATUS FOR STORING AND APPLYING MAGNETIC FIELDS

(76) Inventor: Kim Shallcross, Meaford (CA)

Correspondence Address: HARNESS, DICKEY & PIERCE, P.L.C., P.O. BOX 828, BLOOMFIELD HILLS, MI, 48303, US

(21) Appl. No.: 12/744,817

(22) PCT Filed: Nov. 27, 2007
(86) PCT No.: PCT/CA07/02131

§ 371 Date: Oct. 25, 2010

(51) Int. Cl. A23L 1/025; H01F 7/02; A47G 33/00; B03C 1/02

(52) U.S. Cl. 426/241; 335/306; 210/695

(57) ABSTRACT

An apparatus is provided for storing magnetic fields generated by a rotating array of magnets. The device consists of a housing of non-magnetic material supporting an array of magnets disposed in the housing according to a pattern conforming with sacred geometry. A method is provided for applying, in a remote location, magnetic fields generated by a magnetic field generator having an array of magnets rotating about an axis. The method comprises the steps of: (i) obtaining an apparatus as described above; (ii) placing the apparatus in a magnetic field being generated by the magnetic field generator for a period of time sufficient for the apparatus to absorb a beneficial amount of the magnetic field; and, (iii) transporting the apparatus with the absorbed field to the remote location and placing the apparatus adjacent an item to be purified.

### FIELD OF THE INVENTION

The present invention relates generally to the use of rotating magnetic fields for the purification of food, water, air and soil and direct application to human and animal body surfaces for healing. More particularly, the invention relates to the storage of such fields in non-rotating portable devices.

### BACKGROUND OF THE INVENTION

Devices have been developed which utilize the effect of rotating magnetic fields to purify water, food and the like. An early such device is disclosed in Applicant's International Application No. WO/2004/007377. This device utilizes an array of magnets disposed concentrically about a rotatable shaft. Rotation of the shaft generates a magnetic field which produces beneficial purifying effects.

The earlier device is rather bulky and uses a large electric motor to rotate a heavy circular array of magnets to achieve its results. More effective and compact devices have been invented by the present inventor which utilize shaped magnetic elements arranged in patterns according to “sacred geometry”, an expression which is discussed in more detail below. Such devices are described in the inventor's co-pending Canadian Patent Application Nos. 2,488,776, and 2,526,977; U.S. Patent Application No. US2006/01938891A1, and PCT International Application No. PCT/CA2006/001984.

Despite the inventive improvements embodied in the more recent applications which have made the devices more effective and smaller, heretofore treatment has required proximity of what is being treated to the device. This may be impractical in some applications such as in ongoing treatment of users and in treating food or beverages prior to consumption in public places such as at restaurant tables.

It is an object of the present invention to provide a device for storing magnetic energy from a field generating apparatus such as described above which device may in turn be readily carried by a user to apply the magnetic field in a location remote from the field generating device.

The term “sacred geometry” refers to a number of basic geometrical patterns and figures which embody one of five basic geometrical ratios: Pi, √2, √5, √3, Phi.

Pi is the ratio of the diameter of a circle to its circumference.

√2 is the length of the diagonal of a square with sides of length 1.

√5 is the length of a diagonal of a rectangle with sides 1 and 2.

√3 is the length of a cord connecting the points of intersection of two circles of radius 1, when the circumference of each intersects the centre of the other.

Phi-1+√5/2 is a naturally occurring ratio prevalent in animal and plant skeletal structures; it is also referred to as the “golden ratio”. Most naturally occurring fractal patterns, such as snow flakes, tree shapes and so on, follow the golden ratio.

Sacred geometrical patterns, then, are patterns constructed using the sacred geometrical ratios, and are exemplified by the Seed of Life pattern, which will be used herein for example purposes. Other sacred geometrical shapes and patterns include, but are not limited to, pentagons, pentagrams, hexagrams, equilateral triangles, squares, rectangles with a 2:1 ratio, vesica pisces, and three-dimensional structures including the pyramid and the Kathara grid. Other shapes and structures will be apparent to one versed in the field.

The Seed of Life may be regarded as a component of the Flower of Life. The Seed of Life is derived from a series of six overlapping circles overlying a central circle. The centre of the each of the six overlapping circles is on the circumference of the centre circle.

The Flower of Life is a geometrical figure composed of multiple evenly-spaced, overlapping circles, arranged in a flower-like pattern with six-fold symmetry. The centre of each circle is on the circumference of six surrounding circles of the same diameter. In other words the Seed of Life pattern is a repeated element of the Flower of Life.

References discussing sacred geometry and sacred geometrical patterns include the following: “Secrets in the Fields: The Science and Mysticism of Crop Circles” by Freddy Silva; “The Ancient Secret of the Flower of Life: Volume 1” by Drunvalo Melchizedek; “A Beginner's Guide to Constructing the Universe: (The Mathematical Archetypes of Nature, Art and Science, A Voyage from 1 to 10)” by Michael S. Schneider.

### SUMMARY OF THE INVENTION

An apparatus is provided for storing magnetic fields generated by a rotating array of magnets. The device consists of a housing of non-magnetic material supporting an array of magnets disposed in the housing according to a pattern conforming with sacred geometry.

Each magnet of the array of magnets may be a lens-shaped profile and the magnets may be disposed in a seed of life pattern.

The housing may be a non-magnetic matrix in which the magnets are embedded.

The apparatus may include attachment means for attaching the apparatus to user. The attachment means may be a strap.

The invention recognizes the use, for storing a magnetic field generated by a rotating array of magnets, of an apparatus as described above.

A method is provided for applying, in a location remote therefrom of magnetic fields generated by a magnetic field generator having an array of magnets rotating about an axis. The method comprises the steps of:
(i) obtaining an apparatus as described above;
(ii) placing the apparatus in a magnetic field being generated by the magnetic field generator for a period of time sufficient for the apparatus to absorb a beneficial amount of the magnetic field; and,
(iii) transporting the apparatus with the absorbed field to the remote location and placing the apparatus adjacent an object to be purified.

### DESCRIPTION OF DRAWINGS

Preferred embodiments of the invention are described below with reference to the accompanying illustrations in which:

FIG. 1 is a schematic cross-sectional view of a prior art magnetic field generator containing a rotating array of magnets;

FIG. 2 is a plan view of an apparatus according to the present invention for storing magnetic fields generated by a rotating array of magnets;

FIG. 3 is a sectional view on line 3-3 of FIG. 2;

FIG. 4 is a sectional view on line 4-4 of FIG. 2;

FIG. 5 is a schematic of an embodiment of the present invention similar in part to the FIG. 2 embodiment but including a further array of magnets within a hemispherical housing;

FIG. 6 is a sectional view on line 6-6 of FIG. 5; and,

FIG. 7 is a sectional view on line 7-7 of FIG. 6.

### DESCRIPTION OF PREFERRED EMBODIMENTS

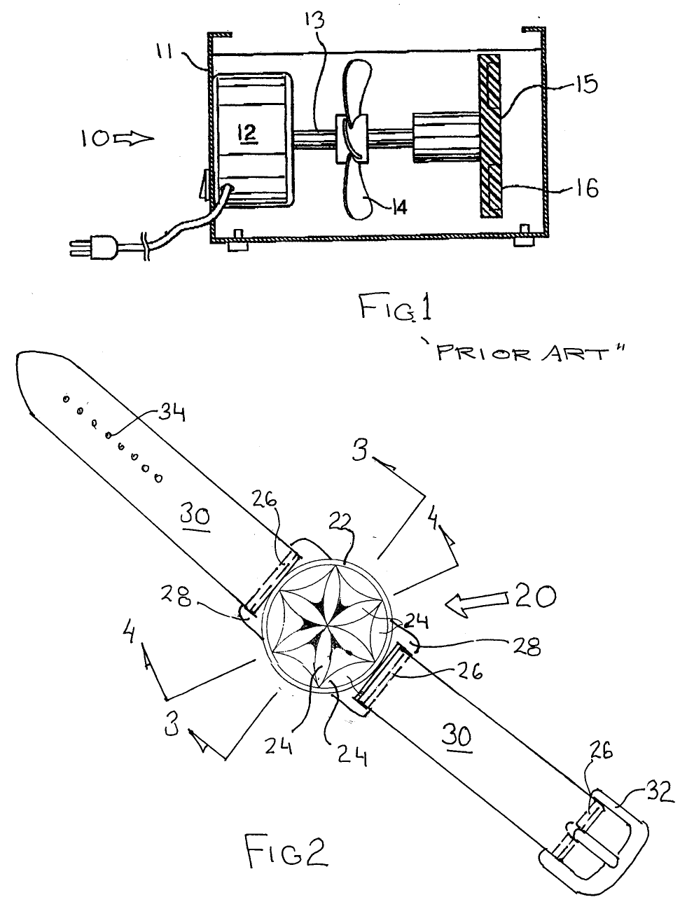

A typical prior magnetic field generator for generating a purifying field is generally illustrated by reference 10 in FIG. 1. The magnetic field generator 10 may be mounted in a box 11 with access to the interior thereof being possible by the removal of fasteners such as bolts or screws.

A motor 12, such as an electric motor, is mounted in the box 11. Motor 12 is typically powered by connection to the electrical mains, but may alternatively be battery powered, solar powered, hand-cranked, or powered by any other known means. Motor 12 has a driven rotating shaft 13 extending therefrom, A cooling fan 14 may be mounted on the shaft, to keep the motor cool during long periods of operation, for instance if the device is being used to treat a water supply.

At the end of the shaft 13 is mounted a support plate 15, onto which magnets 16 are fastened. The plate may be made of any suitable substance, such as high density polyethylene. Magnets 16 are typically strong magnets such as iron boron neodymium magnets, available from a number of sources.

The magnets 16 are laid out in a sacred geometrical pattern and affixed to support plate 15. Preferably, the pattern will be rotationally symmetrical about the centre of shaft 13, to permit the plate to rotate without wobbling.

The magnets 16 are cut, for instance by laser cutting, but by any suitable means, into the lens shape of the elements of the seed of life, in the embodiment illustrated. The magnets, it will be noted, may be electromagnets, or permanent magnets, since the field created will not differ substantially.

The magnetic field generator 10 has practical application as a means to purify water or food, to kill pathogens and break down toxins. The magnetic field generator 10 is also useful for direct application to a human body to assist in restoring circulation, treating inflammation, ulceration, viral and bacterial infections, and as a general tonic.

The illustrated magnetic field generator 10 is exemplary as other arrangements may be utilized. The above described magnetic field generator accords with the inventor's U.S. Patent Application No. 2006/0138891A1 referred to above. Other examples of such devices are described in the inventor's other applications referred to in the background above. The use of the apparatus of the present invention is not restricted to any specific magnetic field generator as long as the generator generates a magnetic field capable of purification and treatment as set out in the preceding paragraph.

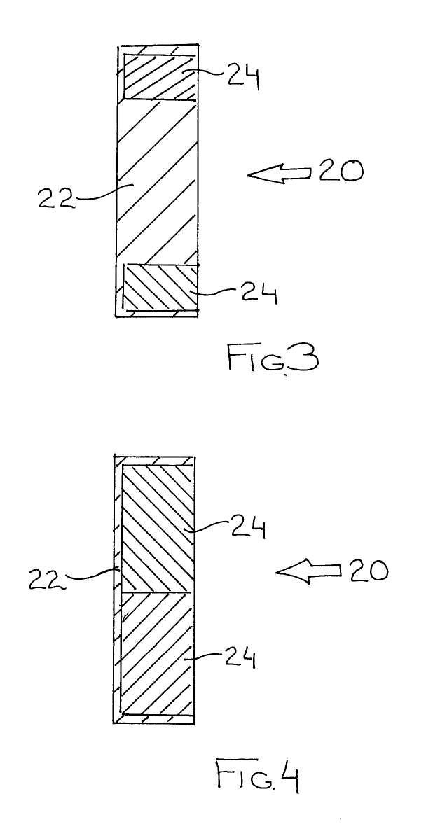

An apparatus according to the present invention for storing magnetic fields generated by a rotating array of magnets is generally indicated by reference 20 in FIGS. 2, 3 and 4. The apparatus 20 comprises a housing 22 of a non-magnetic material which supports an array of magnets 24 disposed in a pattern according to sacred geometry.

A variety of patterns incorporating sacred geometry may be utilized. The one illustrated is known as a “seed of life” pattern. The seed of life pattern is particularly advantageous in that it concentrates the overlapping fields of a large number of magnets 24 in a tight, rotationally symmetrical pattern. The magnets 24 may be cut, for instance by laser cutting, into elements having a lens-shaped profile as seen in FIG. 2.

The housing may be a non-magnetic matrix in which the magnets 24 are embedded. As illustrated the magnets may be embedded with one face visible. Alternatively the magnets 24 may be entire covered by a matrix. A suitable matrix material is epoxy resin however thermoplastic and thermal plastic resins may be used as well as chemically setting plastic materials such as epoxy and non-magnetic metals such as aluminium.

Although embedding is desirable from the standpoint of aesthetics and holding the magnets 24 securely, it is not a requirement. The housing 22 may simply be disk or cup-shaped with the magnets adhered thereto.

The magnets are preferably arranged with north and south poles alternating.

The device 20 may be of a size and configured to be readily portable such as in a handbag or pocket to be held against any item to be purified. Alternatively, and as illustrated, the apparatus 20 may include attaching means such as the strap 30 for attaching the apparatus to a user. The strap 30 may be similar to a watch strap and include holes 34 at one end for engaging a buckle 32 at an opposite end. Protrusions 28 extending from the housing 22 may be used which receive a pin 26 extending through a loop in the ends of the strap 30 such as is commonly done with watch straps. The foregoing is exemplary. A strap with hook and loop fasteners or an elastic loop would be but two of other suitable attachment means. The strap may be otherwise fastened to the housing 22.

Although the patterns illustrated are somewhat two-dimensional in that the seed of life is embedded in a disk, three-dimensional arrays may also be used. The disk-like arrangement is convenient for attachable devices such as illustrated because of its compactness. Many other configurations are possible. One example would be the arrangement utilized for the rotatable magnet in Applicant's above reference PCT application. Examples of other “three-dimensional” arrangements include those illustrated and described in the references set out in paragraph [0015] above and other references describing sacred geometrical shapes.

In use, the apparatus 20 is placed in a magnetic field being generated by a magnetic field generator such as the magnetic field generator 10 described above. The apparatus 20 would be held in the field for a period of time sufficient for the apparatus to absorb a beneficial amount of a magnetic field. The actual amount of time will vary depending on the strength of the field being generated by the magnetic field generator 10, the size and strength of the magnets 24 and the apparatus 20, the particular sacred geometrical pattern embodied in the apparatus 20 and the desired use of the apparatus 20.

Once the apparatus 20 has absorbed a sufficient amount of magnetic field it may be removed from the vicinity of a magnetic field generator 10 and transported to a desired remote location. The apparatus 20 may be worn by a user on their wrist or about their ankle. Alternatively the device may be carried in a pocket or other container to a site where an item is to be purified. For example, the device may be placed on a table in a restaurant adjacent plates and beverage glasses, the contents of which are to be purified.

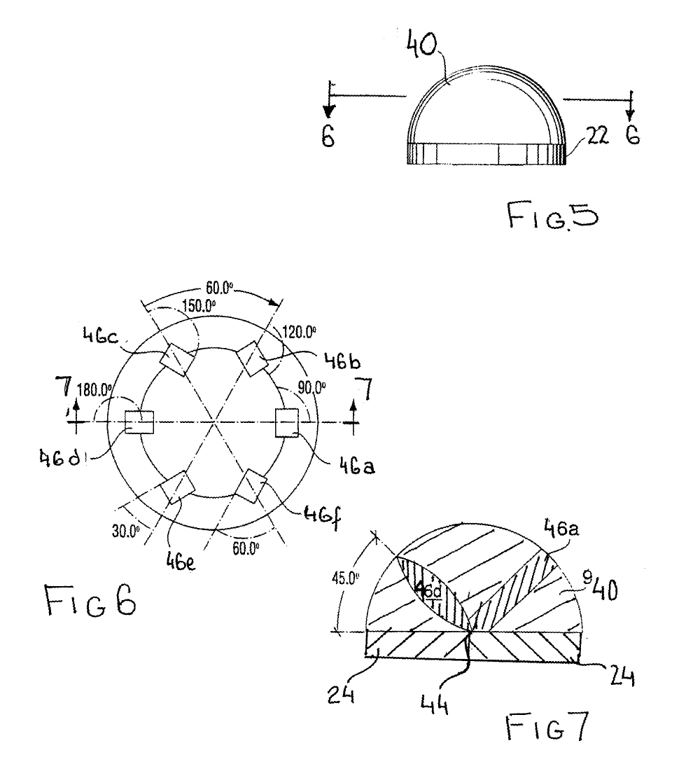

As mentioned above, a variety of patterns incorporating sacred geometry may be utilized. The seed of life pattern is but one. FIGS. 5, 6 and 7 illustrate an embodiment including a series of six magnets 46a, 46b, 46c, 46d, 46e and 46f, mounted in a matrix 40 of a non-magnetic plastic material such as polyethylene, polyurethane, epoxy, aluminum or other non-magnetic matrix material. The matrix 40 is either molded around the magnets to fix and replace or provided with slots each adapted to receive a magnet.

The arrangement illustrated in FIGS. 5, 6 and 7 includes a housing 22 as described above containing a “two-dimensional” array of magnets disposed in a seed of life pattern as described above. Adjacent the housing 22 is a matrix 40 containing six magnets 46a, 46b, 46c, 46d, 46e and 46f mounted in the matrix 40 with one end near the radial centre 44 (corresponding with the centre of the seed of life pattern) of magnets 24 disposed in the housing 22. The magnets 46a-46f extend away from the housing 22 in an “inverted pyramid” or “inverted cone”-like configuration having an apex at the centre 44. FIG. 7 illustrates an angle of approximately 45° however other angles may be used.

Each of the magnets at 46a-46f is rotated about its longitudinal axis by 30° relative to its clock-wise neighbour, whereby diametrically opposed magnets 46a and 46d are rotated by 90° relative to each other. The overall arrangement is not unlike the three-dimensional array of magnets utilized in the rotatable magnetic head of applicant's co-pending Canadian Patent Application No. 2,526,977 disclosed in the background hereto.

It will be understood that other three-dimensional arrays of magnets may be utilized in association with a pattern according to sacred geometry. The expression “according to sacred geometry” is intended to encompass combinations of patterns wherein arrays which accord with sacred geometry are combined with other arrays of magnets which do not.

The above invention is described in an illustrative rather than a restrictive sense. Variations to the exact configurations illustrated may be apparent to persons skilled in the art without departing from the spirit and scope of the invention as defined by the claims set out below.

1. An apparatus for storing magnetic fields generated by a rotating array of magnets, said device consisting of:
a housing of non-magnetic material, supporting an array of magnets disposed in said housing at least some of said magnets being disposed according to a pattern conforming to sacred geometry.

2. An apparatus as claimed in claim 1 wherein:
each magnet of said array of magnets is lens-shaped in profile; and,
said magnets are disposed in a seed of life pattern.

3. An apparatus as claimed in claim 1 wherein said magnets and said array of magnets are disposed with respect of north and south poles alternating.

4. An apparatus as claimed in claim 1 wherein said housing is of a non-magnetic matrix embedding said magnets.

5. An apparatus as claimed in claim 1 further comprising attachment means, for attaching said apparatus to a user.

6. An apparatus as claimed in claim 5 wherein said attachment means includes provision for securement of a strap.

7. An apparatus as claimed in claim 1 wherein said array of magnets is grouped in first and second arrangements, with said first arrangement adjacent said second arrangement;
said first arrangement of magnets is a sacred geometrical pattern;
said second arrangement of magnets includes a plurality of said magnets disposed generally equidistantly about a geometrical centre of said first arrangement in a generally pyramid or cone-shaped pattern or shaped with vertex of said pyramid or cone facing said first arrangement.

8. The apparatus of claim 7 wherein said magnets in said second arrangement of magnets have descernible front and rear faces on opposite sides of the longitudinal axis;
said magnets are arranged with said longitudinal axis lying along said pyramid or cone shape;
each said magnet is rotated by an equal amount in a common direction from its neighbour whereby diametrically opposed magnets have respective of said front and rear faces facing in generally perpendicular directions.

9. The apparatus of claim 8 wherein said magnets in said first and second arrangements have generally planar side faces joined by curved front and rear faces which meet at opposite ends to present a lens-like profile when viewed from the front or rear faces and a generally rectangular profile when viewed from said side faces.

10. An apparatus as claimed in claim 9 wherein said housing is of a non-magnetic matrix embedding said magnets.

11. The use for storing a magnetic field generated by a rotating array of magnets of an apparatus as claimed in claim 1.

12. A method for applying, in a location remote thereto, magnetic fields generated by a magnetic field generator having an array of magnets rotating about an axis, said method comprising the steps of:
(i) obtaining an apparatus as claimed in claim 1;
(ii) placing said apparatus in a magnetic field being generated by said magnetic field generator for a period of time sufficient for said apparatus to absorb a beneficial amount of said magnetic field; and,
(iii) transporting said apparatus with said absorbed field to said remote location and placing said apparatus adjacent an item to be purified.
